(19) United States
(12) Patent Application Publication
(10) Pub. No.: US 2017/0371633 A9
(43) Pub. Date: Dec. 28, 2017

(54) CAR APPLICATION INTERFACE

(71) Applicant: Steven Ohmert, Vashon, WA (US)

(72) Inventor: Steven Ohmert, Vashon, WA (US)

(21) Appl. No.: 14/320,634

(22) Filed: Jun. 30, 2014

Related U.S. Application Data
(60) Provisional application No. 61/841,421, filed on Jun. 30, 2013.

(51) Int. Cl. G06F 9/45; G06F 9/44

(52) U.S. Cl. CPC G06F 8/40; G06F 8/70

(57) ABSTRACT

A system, method and apparatus for a car application interface is provided. In an embodiment, a method is provided. The method includes receiving, in a host car system, an application request in a first format compatible with an application encoding format from an application. The method also includes transforming, in the host car system, the application request into a second format compatible with the host car system. The method also includes sending, in the host car system, the application request in the second format compatible with the host car system to the host car system. The method further includes receiving, in the host car system, a car response from the host car system in the second format compatible with the host car system. The method includes transforming, in the host car system, the car response into the first format compatible with the application encoding format. The method includes sending, in the host car system, the car response in the first format to the application.

### CLAIM OF PRIORITY

This application claims the benefit of priority to U.S. Provisional Patent Application No. 61/841,421, entitled “CAR APPLICATION INTERFACE” and filed on Jun. 30, 2013, which is hereby incorporated herein by reference in its entirety.

### BACKGROUND

Makers of computers and mobile devices have over the years, benefited from a leveraged pool of labor far beyond what those makers actually employ. For example, DOS-based and Windows-based personal computers and corresponding Apple computers such as the Macintosh, benefited from third-party software developers who often speculatively develop software for underlying platforms in which they had no ownership or control. This leveraged pool of labor was so important, that computer makers and operating system makers would provide educational materials and instruction to software developers to encourage third-party software development on their platforms. Moreover, developer adoption of or migration to new platforms often proved to be crucial to the success of such platforms.

This stands in contrast with other historical models, such as classic IBM mainframes and competing computers (e.g. from Tandem Computers, for example). For such devices, customization of software by the maker of the computer (e.g. IBM) was the standard, and third-party software development was unusual. A customization model made more sense in situations with mainframes involved, as a transaction might involve one or only a few mainframe computers, and a substantial amount of service revenue for customization.

Interestingly, the model for development of software for cars, so far, he has tended to resemble that of software development for mainframe computers, rather than that of software development for personal computers. It is common for a car manufacturer to develop custom software for a model of car or a set of models of cars (e.g. a make of cars) internally or through a subcontractor, without significant regard for third-party software development. This has led to Balkanization of software development within the car manufacturing community. This also discourages developers of third-party software from attempting to develop software for installation on cars. Thus, it may be useful to provide a system which encourages third-party development of software for use on cars. Moreover, it may be useful to provide a system which allows car manufacturers to work with third-party software developers.

Additionally, while much of our lives involves highly connected data acquisition, cars generally do not allow for this. Cars often have a great deal of data collected internally. However, that data is often trapped within the car, with no effective method available for ongoing access to data or reasonably frequent access to data. Thus, it may be useful to provide a system which allows car manufacturers and car dealers to obtain data about cars on a more frequent basis.

Moreover, cars typically have limited computing resources due to the environment in which the computing resources (e.g. processors, memory, etc.) operate. An environment involving vibrations, bounces, inclement weather, EMF sources and temperature extremes is not conducive to high-precision processing. Thus, it may be useful to provide ways to extend processing power from mobile devices for use in the car environment.

### BRIEF DESCRIPTION OF THE DRAWINGS

The present invention is illustrated by way of example in the accompanying drawings. The drawings should be understood as illustrative rather than limiting.

FIG. 1 illustrates an embodiment of a car and its interactions with other devices or entities.

FIG. 2 illustrates an embodiment of the car and its interaction with other devices under present conditions.

FIG. 3A illustrates a typical manufacturing relationships.

FIG. 3B illustrates potential manufacturing relationships.

FIG. 4 illustrates another embodiment the car and its interactions with other devices or entities.

FIG. 5 illustrates an embodiment of a process of developing an application.

FIG. 6 illustrates interaction between an application and an application platform and interface in an embodiment.

FIG. 7 illustrates an embodiment of an application platform and interface for use in a car.

FIG. 8 illustrates an embodiment of an application platform and interface for use on a mobile device.

FIG. 9 illustrates the embodiments of FIGS. 7 and 8 as they may interact.

FIG. 10 illustrates an embodiment of a process of handling requests between an application and a host car.

FIG. 11 illustrates an embodiment of a system in which applications and an application interface operate on a host car.

FIG. 12 illustrates another embodiment of a car and its interactions with other devices or entities.

FIG. 13 illustrates an embodiment of a process of receiving and using data about cars.

FIG. 14 illustrates another embodiment of a process of receiving and using data about cars.

FIG. 15 illustrates an embodiment of a mobile device or machine which may be used with the illustrated and described encoding schemes.

FIG. 16 illustrates an embodiment of a network which may be used with the mobile device of FIG. 15, for example.

FIG. 17 illustrates an embodiment of a computer or machine which may be used with the network of FIG. 16 and with the illustrated and described encoding schemes, for example.

### DETAILED DESCRIPTION

A method and apparatus is provided for a car application interface. The specific embodiments described in this document represent exemplary instances of the present invention, and are illustrative in nature rather than restrictive.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

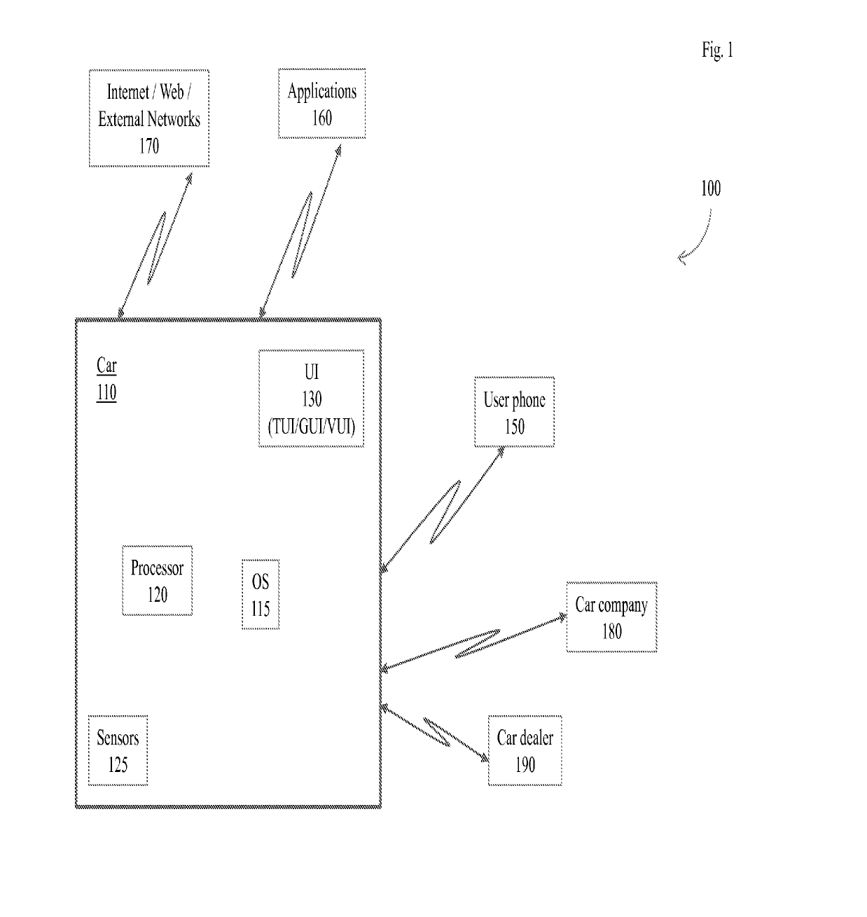

FIG. 1 illustrates an embodiment of a car and its interactions with other devices or entities. Car 110 is illustrated as having a processor 120, sensors 125, operating system 115, and user interface 130. One may expect the processor 120 is an onboard processor which is used to execute operating system 115, went to interact with user interface 130 and sensors 125. Sensors 125 include a variety of onboard sensors in the car which may literally number in the hundreds or thousands for a given car. Operating system 115 provides a local operating system which can interact with sensors 125 user interface 130 and handle other tasks involved in operating car 110. Operating system 115 may be accustomed more semicustom operating system for a particular type of car.

User interface 130 may involve a touch user interface, graphical user interface, and voice user-interface, all of which may be understood to constitute the user interface 130. The user interface 130 may not include all three types of user interfaces every car 110. User interface 130 may allow for control of some car systems, such as climate control, audio control (e.g. radio), and GPS control, for example. User-interface 130 thus may accept commands from touch, voice, and manipulation of controls, for example. Similarly, user interface 130 may provide feedback of some form through some or all of these control modes.

Shown in system 100 is interaction between the car and a user phone 150, applications 160, external networks 170, a car company 180, and a car dealer 190. Not shown is how this interaction may happen. Current systems allow some interaction with the user phone 150 through Bluetooth, for example. Car dealer 190 may be expected to receive some information through legacy interfaces, such as port for code readers. This is a very limited way to access data however. Additionally, some information may be available through access to a black box recorder which may be onboard car 110 (not shown). Providing access to applications 160 external networks 170 the car company 180 is not clearly available using current technology.

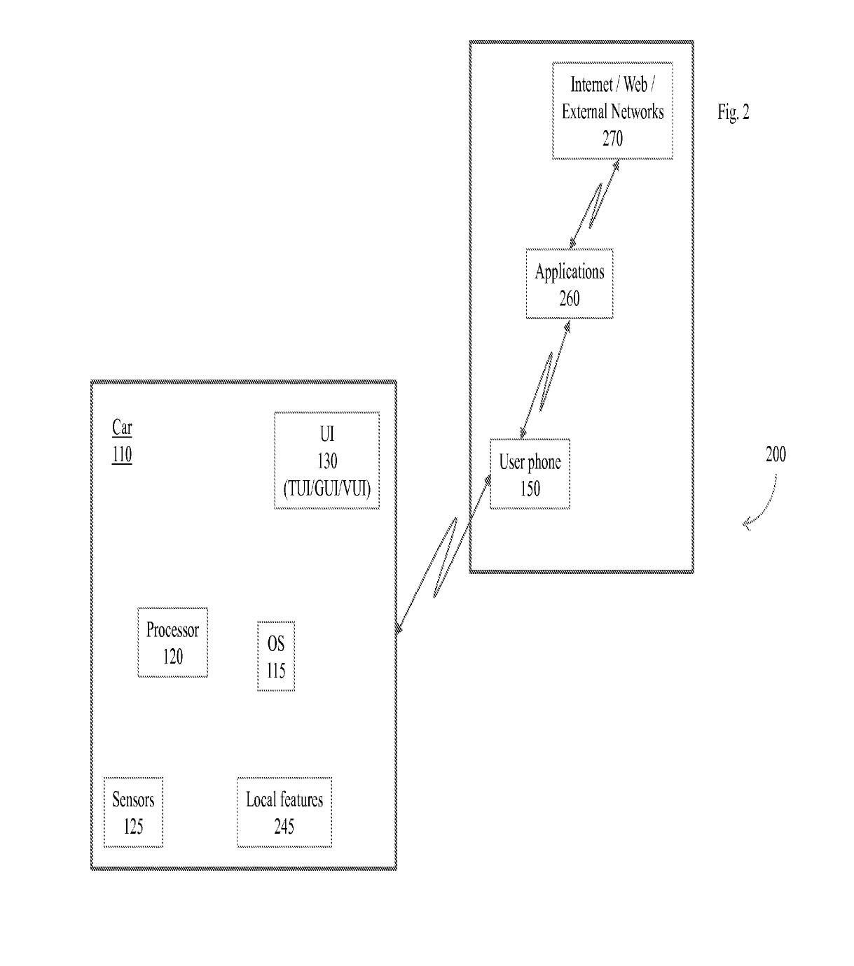

FIG. 2 illustrates an embodiment of the car and its interaction with other devices under present conditions. The current solution to the desired illustration of FIG. 1 is somewhat approximated by what is shown as system 200 in FIG. 2. Local features 245 are provided as controls for internal car systems such as climate control, audio control and GPS systems. Additionally, access to a user phone 150 may allow for display of phone applications 260 and even access to external networks 270 through use of the user phone 150. However, this does not allow the car to communicate with applications 260 or to use external networks 270. This only potentially allows a user to access some limited functionality through the user phone 150.

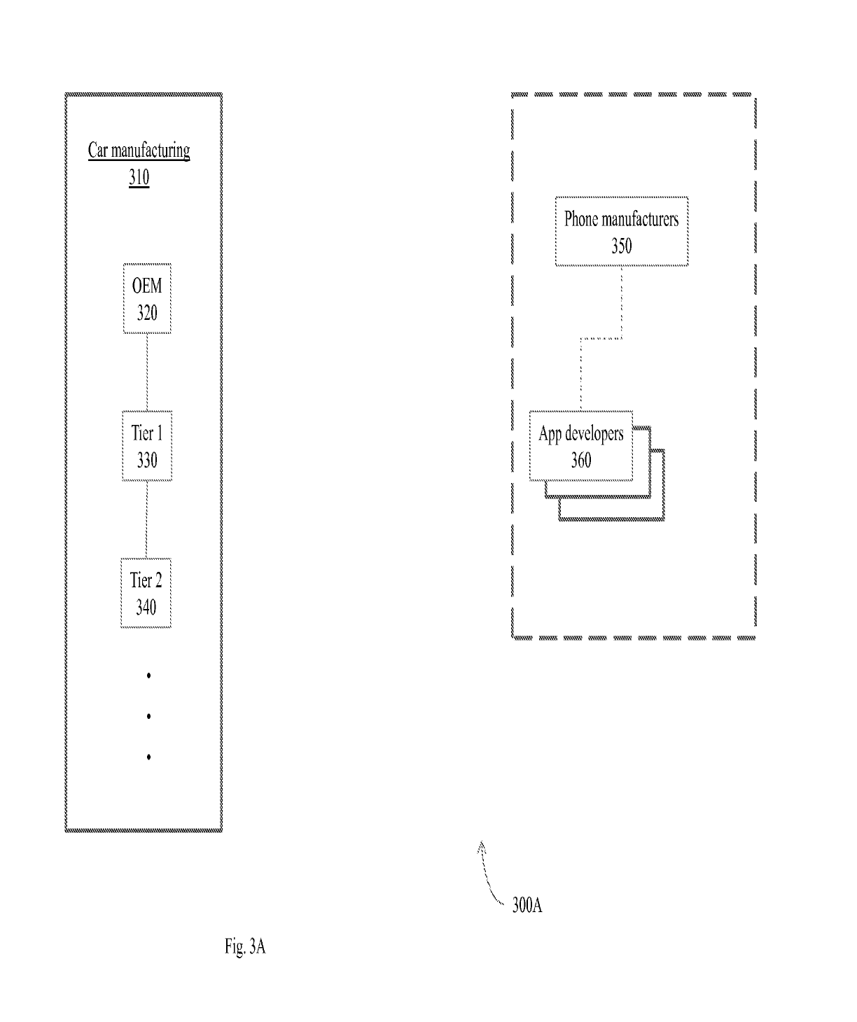

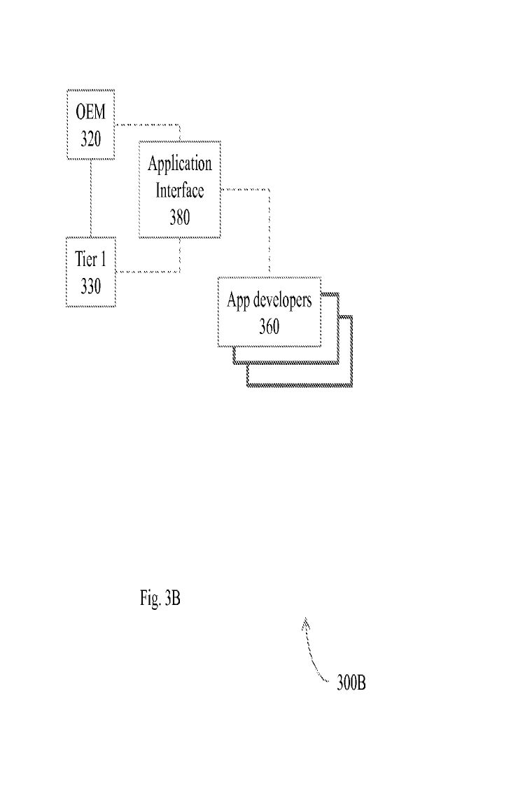

Current manufacturing relationships contribute to the limited systems available. FIG. 3A illustrates a typical manufacturing relationships. As shown in system 300 A, car manufacturing 310 involves an OEM 320 working with a tier 1 manufacturer 330, a tier 2 manufacturer 340 and other potential participants. Phone manufacturers 350 work with outside app developers 360. These two systems basically do not communicate, and do not share resources.

With development of an interface suitable for development of applications, a different system may arise. FIG. 3B illustrates potential manufacturing relationships. System 300B shows OEM 320 and tier 1 manufacturer 330 working through an application interface 380 with app developers 360. This provides the potential for allowing app developers 360 access to an additional market available on cars. This also provides the potential for allowing OEM 320 to provide a much richer set of functionality for selection by purchasers of cars.

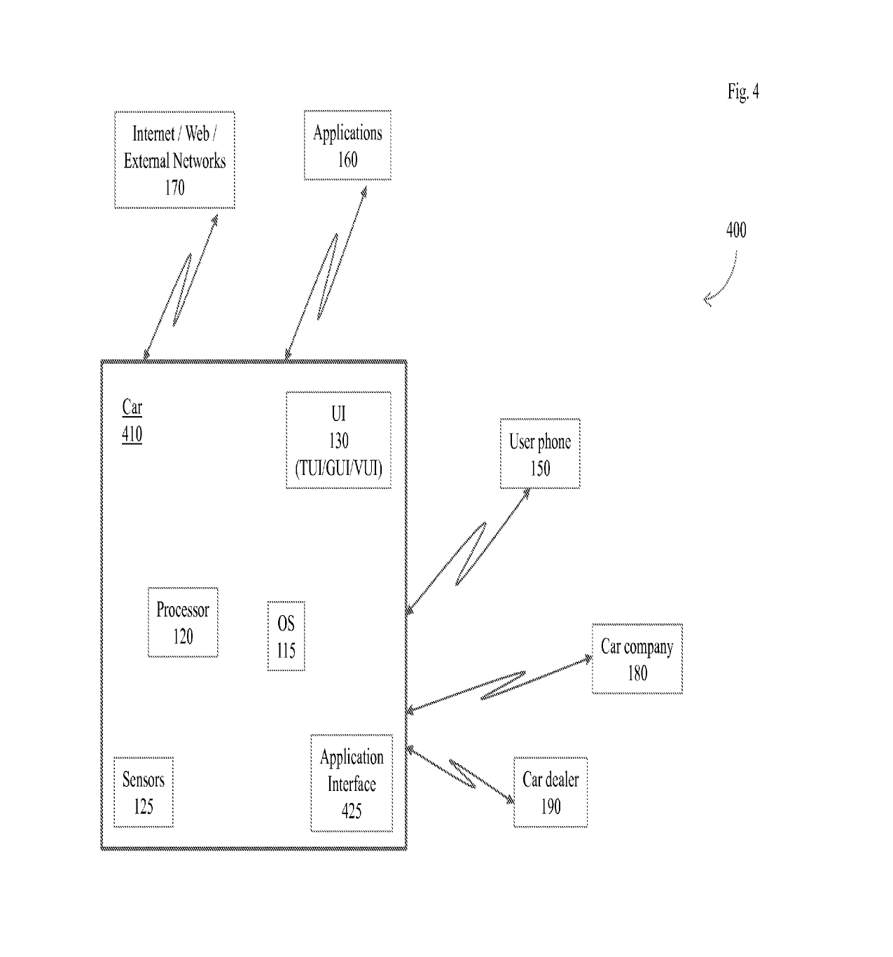

Thus, one can see how the addition of an application interface may allow the promise of FIG. 1 to be realized. FIG. 4 illustrates another embodiment the car and its interactions with other devices or entities. As illustrated, application interface 425 is provided as part of car 410. Application interface potentially allows for use of external networks 170 to communicate with car dealer 190 and car company 180. Application interface for 25 also potentially allows for use of applications which are loaded into car 410 and for enhanced communication with user phone 150.

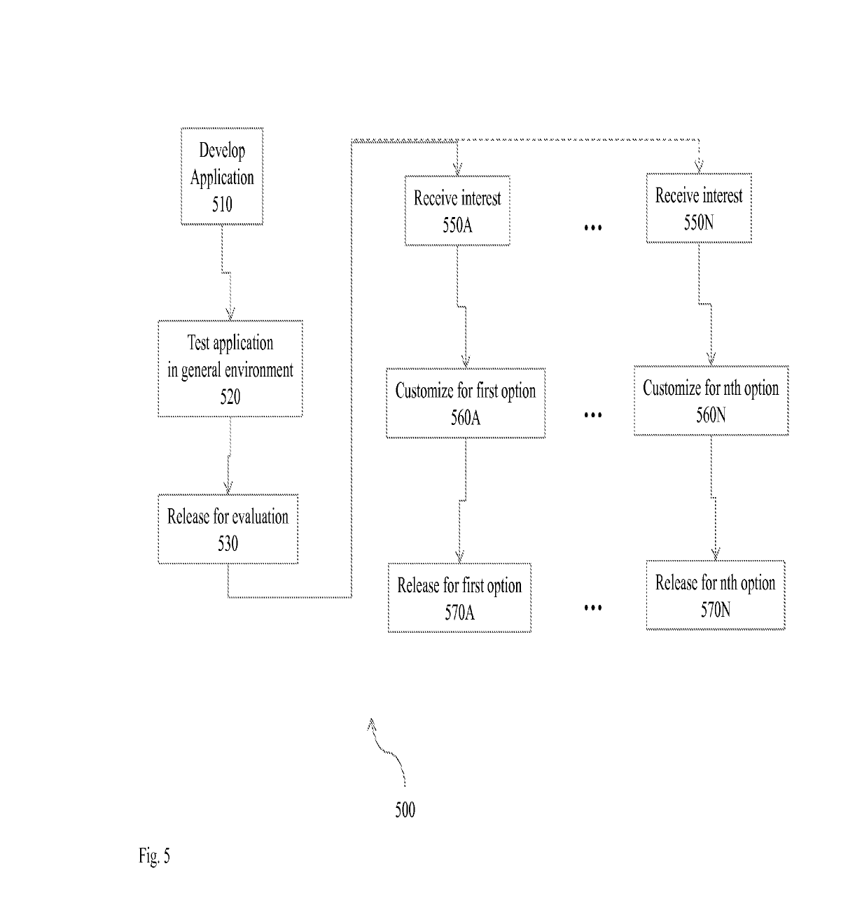

FIG. 5 illustrates an embodiment of a process of developing an application. One can expect the development of applications will in some ways proceed along recognized lines. However, process 500 illustrates the development of an application may involve developing an initial application, testing the application and the general environment, releasing that application for evaluation, receiving interest from one or multiple parties, customizing for the one or multiple parties and then releasing the photos one or more parties. Process 500 and other processes referred to in this document are described as a set of modules, which may be executed or implemented in a variety of ways, whether by a pre-programmed machine, a specialized machine, or a set of machines, and which may be re-arranged in order and in serial or parallel fashion within the context of the description.

The process begins with development of application at module 510 then proceeds to testing application general environment at module 520. This may be expected to be something of an iterative or interactive process for the development, testing, further development work, more testing, and so forth. By developing the application for use in the general environment such as software development kit for application platform, one may develop the general application which is potentially useful for a number of different types, makes or models of cars. One of the challenges with cars is that a given model may only have a production run numbering in the hundreds of thousands in a given year. In contrast, multiple millions of films for a given operating system may be activated on a given day. By allowing development for a number of different models and/or makes, this provides the potential scale to much larger numbers of potential customers. With the application developed, it is released for evaluation module 530. The application is then evaluated by car manufacturers or subcontractors. Expressions of interest may then be provided and received at module 550 such as shown as module 550a or 550n. The application is then customized for each specific model or for each maker is appropriate at module 560 such as module 560 A or 560n. The application is customized is then released at module 570.

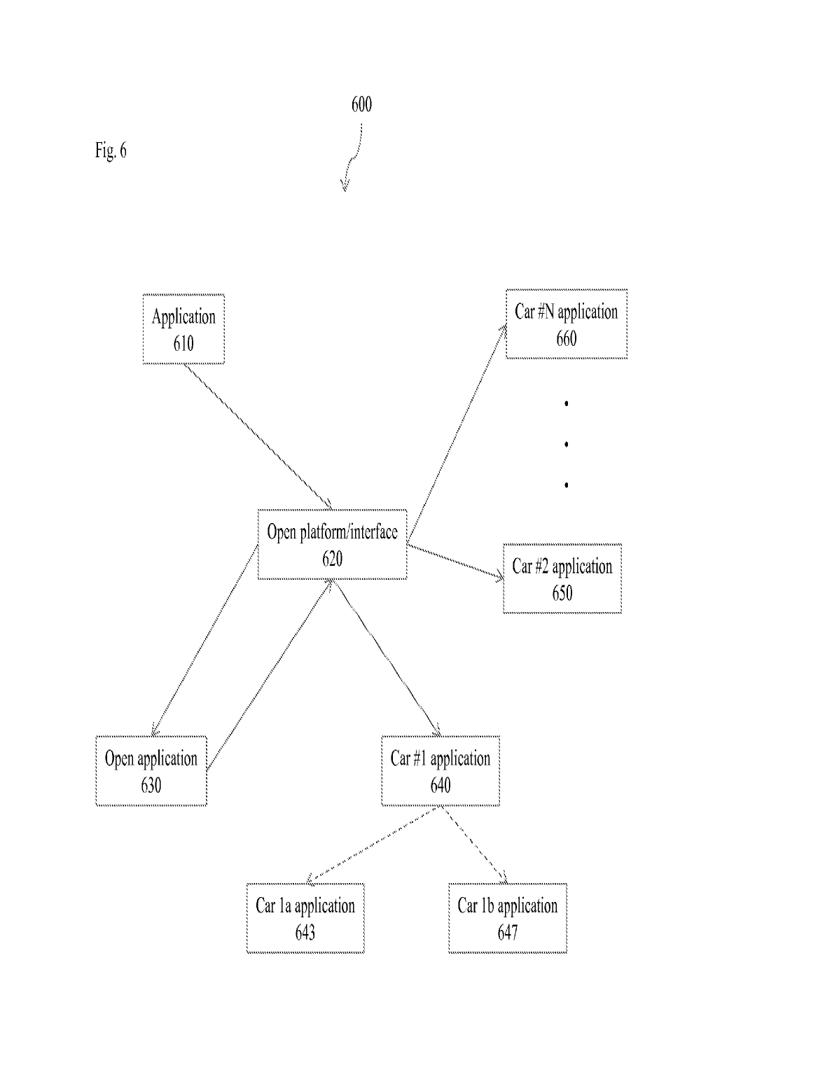

Another way of understanding the process 500 of FIG. 5 is to consider illustration of interactions with FIG. 6. FIG. 6 illustrates interaction between an application and an application platform and interface in an embodiment. Application 610 is developed in system 600 for use with an open platform or interface 620. This provides an open application 630 the open application 630 may then be developed further under the auspices of platform 620 to provide a specific application 640 for a first car model. Variations thereof may result in a first application 643 for a first type of the model and a second application 647 for another type of the model, for example. Open application 630 may also be further developed for a second model as application 650. Similarly it may be developed as an application for an nth model as application 660.

Note that one may expect that the developer of application 610 will customize open application 630 for the first, second and subsequent car models. However, it may be the case that others may cooperate with the developer of application 610 to provide a customized version of application 630 for one or more makes or models of cars. Thus, the opportunity is there for specialists in customizing and modifying occasions to deal with requirements for specific makes or models of cars.

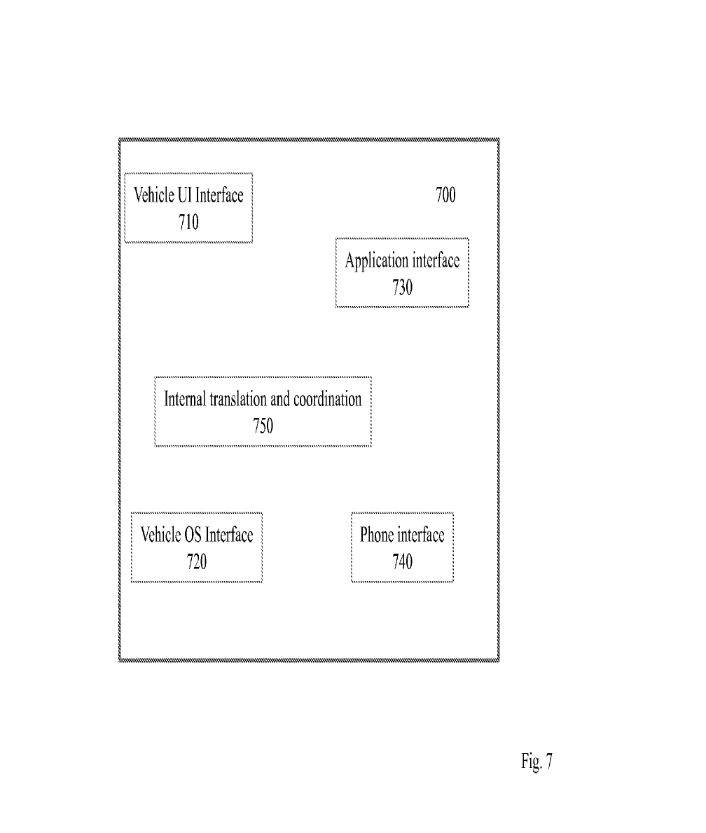

FIG. 7 illustrates an embodiment of an application platform and interface for use in a car. System 700 provides a system which can support applications developed for an open interface while also communicating with internal systems of a car. As illustrated, the vehicle UI interface 710 is provided which interfaces with the various user interfaces of the car. Vehicle OS interface 720 interfaces with the underlying operating system of the car. Application interface 730 interfaces with an application for use with the car. Phone interface 740 interfaces with any present phone or mobile device.

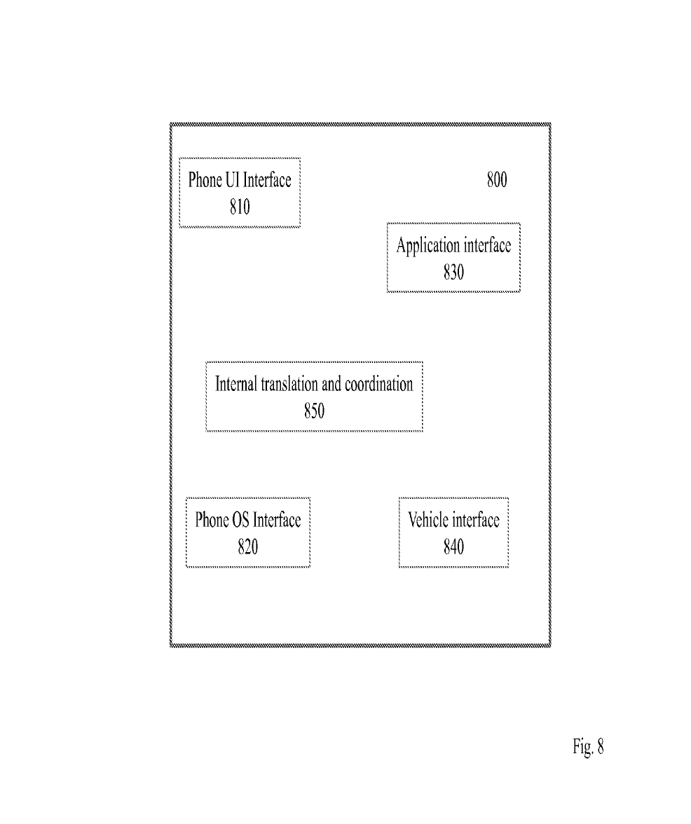

FIG. 8 illustrates an embodiment of an application platform and interface for use on a mobile device. System 800 provides a system which can support applications developed for an open interface while also communicating with internal systems of a phone or mobile device when the phone or mobile device is operating within a car. As illustrated, the phone UI interface 810 is provided which interfaces with the various user interfaces of the phone or mobile device. Phone OS interface 820 interfaces with the underlying operating system of the phone. Application interface 830 interfaces with an application for use with the car. Vehicle interface 840 interfaces with the car (such as through Bluetooth, for example).

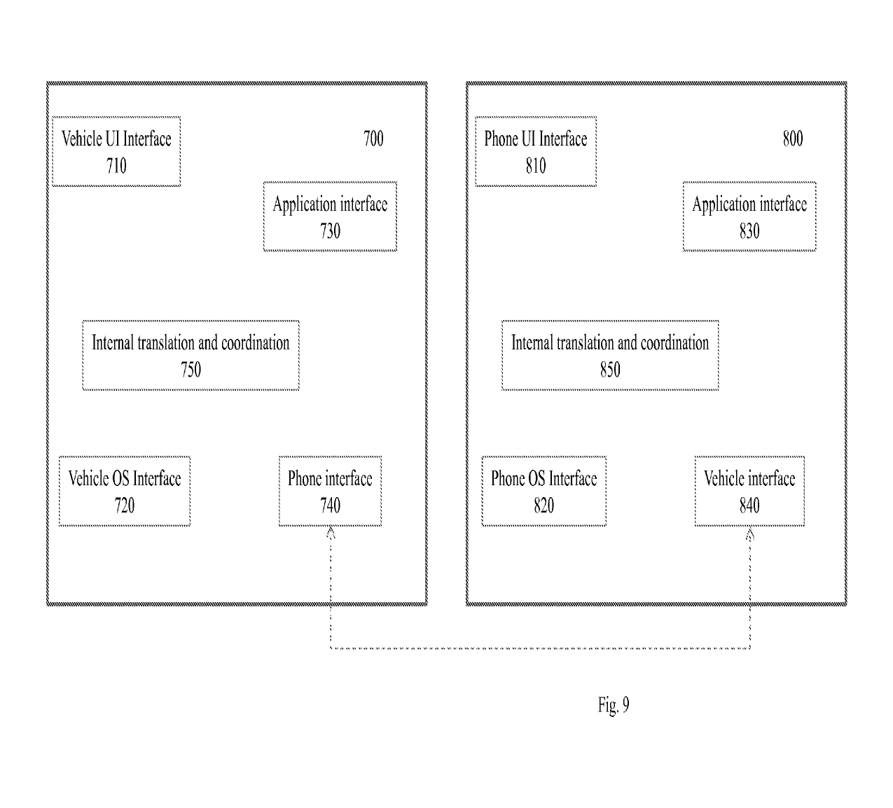

FIG. 9 illustrates the embodiments of FIGS. 7 and 8 as they may interact. As illustrated, phone interface 740 and vehicle interface 840 interact with each other to provide a link between car application platform 700 and phone application platform 800. Thus, one may use a phone or mobile device in conjunction with the car in which the phone or mobile device is operating, and thus may expect to accomplish significantly more than one can do with only one or the other platform.

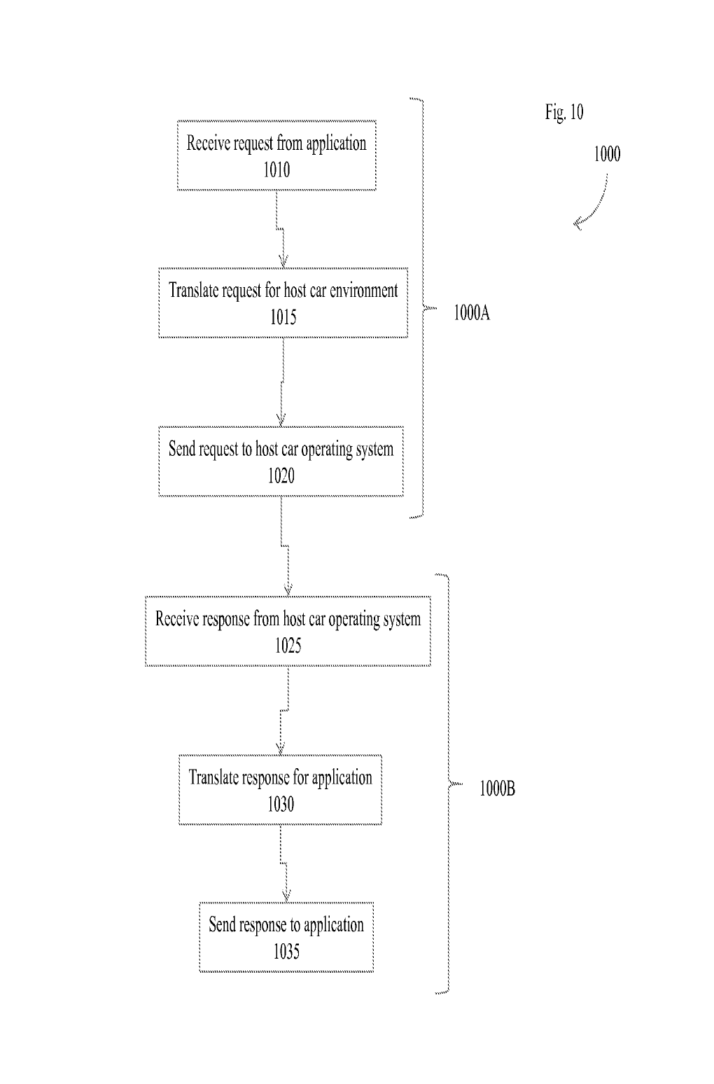

FIG. 10 illustrates an embodiment of a process of handling requests between an application and a host car. Process 1000 can be thought of as two processes, one for sending messages to the host car system from an application and another for receiving messages back from the host car system to the application. Process 1000A includes receiving a request from an application, translating the request and sending the translated request to the host car environment. Process 1000B includes receiving message from the host car system, translating the message and sending the message to the application. Messages from the host car system to the application are treated as responses in this diagram, but may be messages which do not correspond to an original request from the application in some instances.

At module 1010, a request or other message from an application is received by an application interface. This may be supplying information to a host car system or it may be requesting information from the host car system. At module 1015, the message is translated into a format suitable for use by the host car system. This may involve arranging parameters, mapping or translating data, or providing a new message based on the contents of the message from the application. At module 1020, the translated message or request is sent to the host car environment, such as through established APIs (application program interfaces) of the host car operating system. This may involve relatively standardized APIs or specialized APIs for a specific type of car in which the host car operating system operates.

At module 1025, a message is received from the host car operating system. This message comes in a format understood by the host car operating system, but may not be understandable to the application. This message is portrayed as a response, but it may also be an unsolicited message from the operating system of the host car for which no corresponding request exists. At module 1030, the message is translated into a format suitable for use with the application to which the message is directed. At module 1035, the translated message is sent to the application for which it was intended. More aspects of this will be described below, in relation to various embodiments.

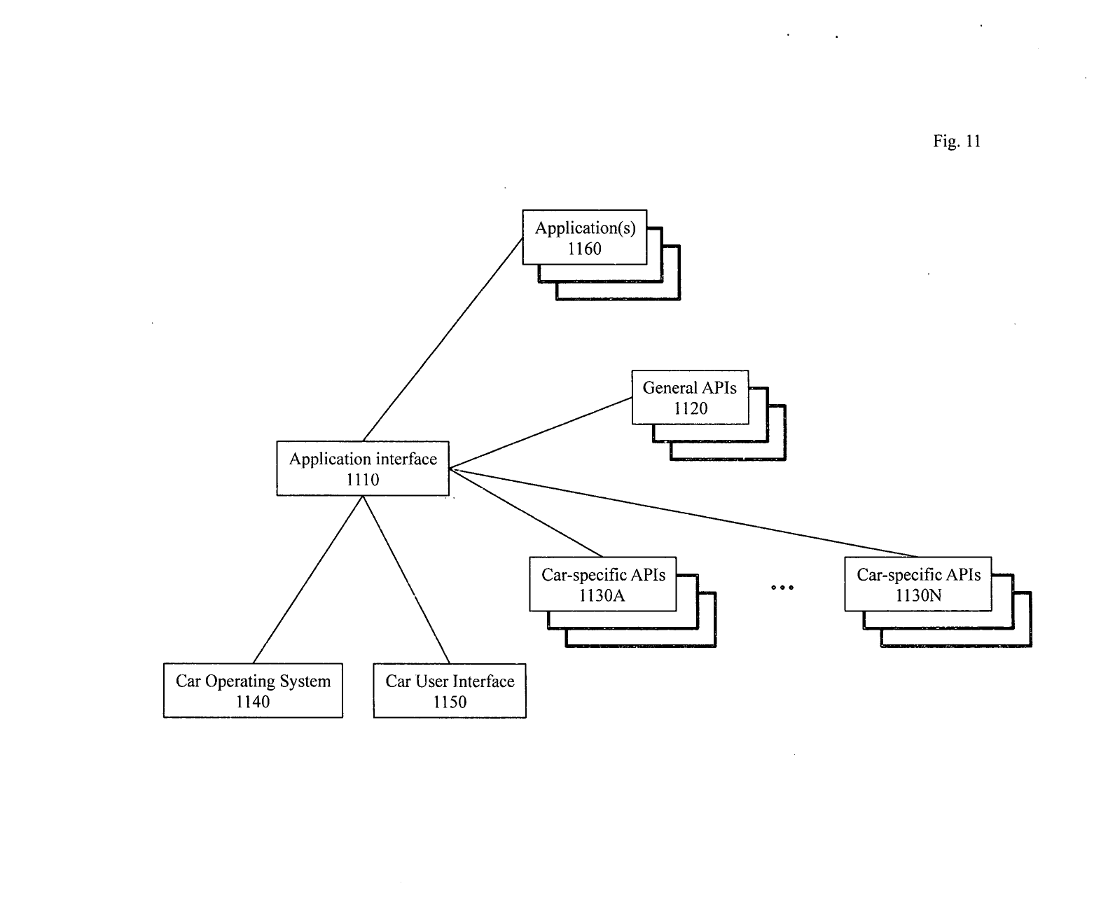

FIG. 11 illustrates an embodiment of a system in which applications and an application interface operate on a host car. Messages are passed through application interface 1110. Applications 1160 can use general APIs 1120 for many expected functions or interfaces, such as obtaining information about speed, remaining fuel/charge, climate control settings, and other information. These general APIs 1120 are accessible to applications 1160 and can be expected to work with most or all cars. Application interface 1110 translates messages received through general APIs 1120 for use by car operating system 1140 and potentially for use with car user interface 1150 if that is available separately from car operating system 1140. Likewise, any information flowing back from car operating system 1140 is translated by application interface 1110 for provision through general APIs 1120 to applications 1160.

In some, potentially all, cars, additional APIs specific to the car will be available. Car-specific APIs 1130A through 1130N are illustrated. These may pertain to specific features, sensors, controls or other specialized aspects of each car. While some cars can be expected to have a sunroof or a convertible top, others would not, for example. Similarly, some cars may have auxiliary power for a towed vehicle, as an example. Thus, specific features of a car which are not part of a general set of APIs 1120 may be exposed for use with applications 1160 through car-specific APIs 1130. Additionally, aspects of general information about a car, such as speed, which exceed the information available through general APIs 1120 may also be exposed through car-specific APIs 1130. Thus, one may customize an application 1160 from a general application for an open platform in part by providing additional information through use of car-specific APIs 1130.

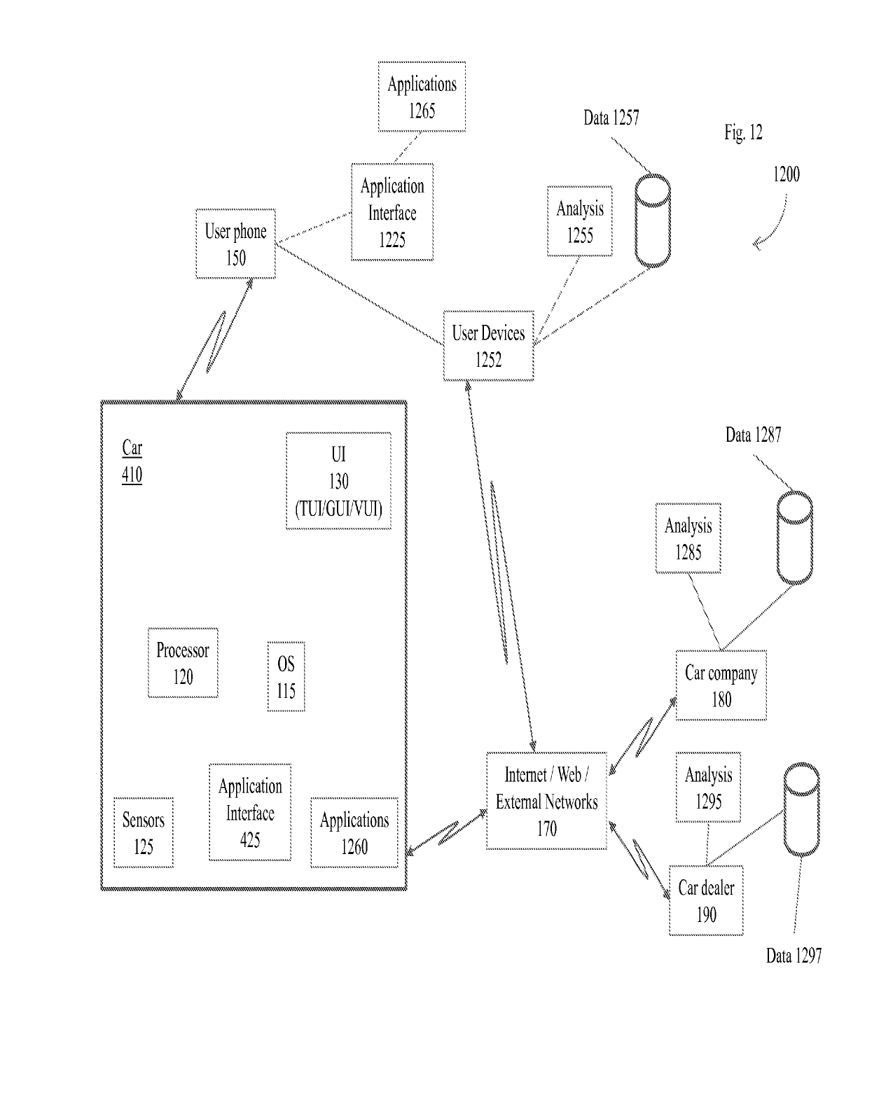

FIG. 12 illustrates another embodiment of a car and its interactions with other devices or entities. System 1200 uses application interface 425 and applications 1260 to provide for additional functionality based on third-party applications along with additional connectivity. Additionally, access to a user phone 150, which may occur through Bluetooth, wi-fi (e.g. IEEE 802.11 standards) or other connections, provides for potential access to applications on the phone 150. Also, applications 1265 on the phone 150 may correspond to applications 1260 in the car 410, and may use a similar or linked application interface 1225 on the phone 150. Thus, processing can be offloaded from the car 410 (and processor 120) to a processor of user phone 150. The application interface 425 can provide for access to user interface 130, operating system 115 and potentially direct access to some sensors 125, too, allowing for use by applications 1260.

Additionally, other user devices 1252 may get access to information about car 410, either through user phone 150 or through other data connections such as external networks 170. A car 410 may have internal hardware for connection to external networks 170 in some instances, allowing for some data transfer. Additionally, car 410 may be equipped to connect to a home network or other external network 170 through interfaces such as a charging interface, for example.

User devices 1252 may allow for use of an analysis module 1255 and local storage of data 1257 related to car 410. Thus, a user may customize features related to the car 410 using a personal tablet or laptop computer as user device 1252, for example. This may be as simple as setting a new internal climate setting of 70 degrees F. (25 C) rather than 75 degrees F. (28 C). However, it may be more complicated, such as invoking environmentally friendly settings for future driving (e.g. acceleration limits, fuel consumption limits, etc.), or changing charging behavior for an electric car (e.g. setting charging to begin at midnight rather than 1:00 AM, for example.

System 1200 also potentially allows for access to data about car 410 by a car company 180 and a car dealer 190, for example. Thus, a car company 180 may receive basic data about the car on a regular basis as transmitted through a phone 150 or through a direct network connection via an external network 170, for example. Car company 180 may then analyze this information through an analysis engine 1285 and store data 1287, for example. Similarly, a car dealer 190 may get data and analyze it using an analysis engine 1295 and store with data storage 1297. This may involve high-frequency or low-frequency collection of data, and may involve varying amounts of data. However, one would expect that, at a minimum, exception data indicating some form of developing problems would be included in any data sent to car manufactures 180 and/or car dealers 190. Moreover, a function of applications such as applications 1260 and 1265 may be to collect some of this data and send it to car company 180 and car dealer 190, for example.

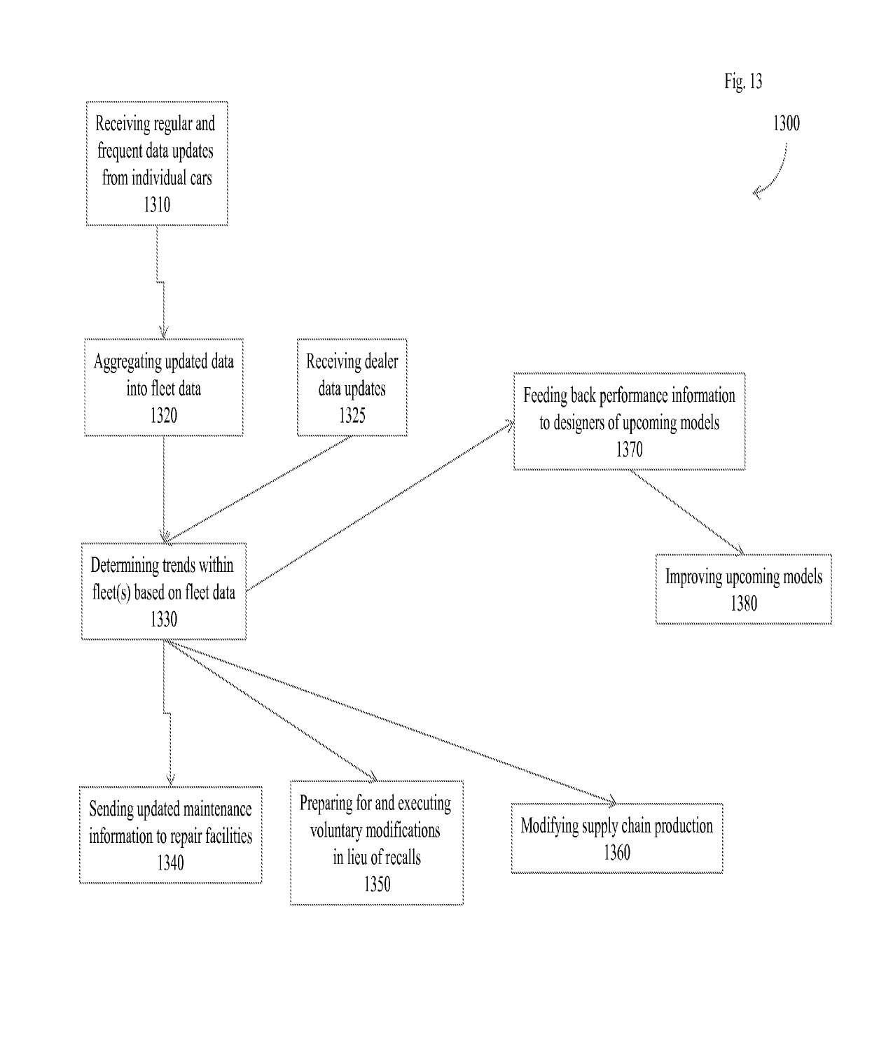

FIG. 13 illustrates an embodiment of a process of receiving and using data about cars. Process 1300 includes receiving data updates, aggregating data, determining trends within the data, and acting based on the data. Process 1300 includes receiving regular and frequent updates from individual cars with data about those cars at module 1310. This may involve use of an application preloaded onto cars at time of manufacture, for example. This may be expected to be a recurring module, even though it is shown as an initial module. Such data may include basic information about use of the car, operation of the car, what unexpected or exceptional events are occurring and other data. At module 1320, the data of module 1310 is aggregated to provide fleet data. Thus, various cars of a selected make and model may be grouped for data purposes, with the associated data for each car provided as part of a larger database for the make and model. Moreover, to the extent that privacy concerns come into play, this can allow for anonymization processes. Additionally, at module 1325, data from dealers can also be integrated into a database used by the car manufacturer. At module 1330, determinations are made about trends in the data, reflecting how a fleet of cars are operating. This may then spawn a number of different operations.

At module 1340, updated repair information is sent to repair facilities by the car manufacturer or a related entity. This may allow for inspection of cars for problems, updated maintenance processes, and other changes to maintenance. Similarly, at module 1350, voluntary modifications to cars may be prepared for and executed, such as through a dealership network or repair facility network. This may allow a car company to anticipate problems with cars (e.g. excessive wear or strain on parts) and replace these parts prior to failures which lead to regulatory scrutiny and harmful publicity. Moreover, at module 1360, supply chain production may be modified, such as through messages to produce more parts, parts with different specifications, or to stop production of spare parts which do not appear to be in demand.

Additionally, at module 1370, information is fed back to designers of upcoming cars about performance. This can be model-specific information which may affect an updated design of a model. Alternatively, it can involve information about parts common across multiple models or makers of cars, such as information about performance of a powerplant used in various cars, for example. Thus may lead to improvements at module 1380 of upcoming models of cars, or even of cars not yet produced for an otherwise existing model.

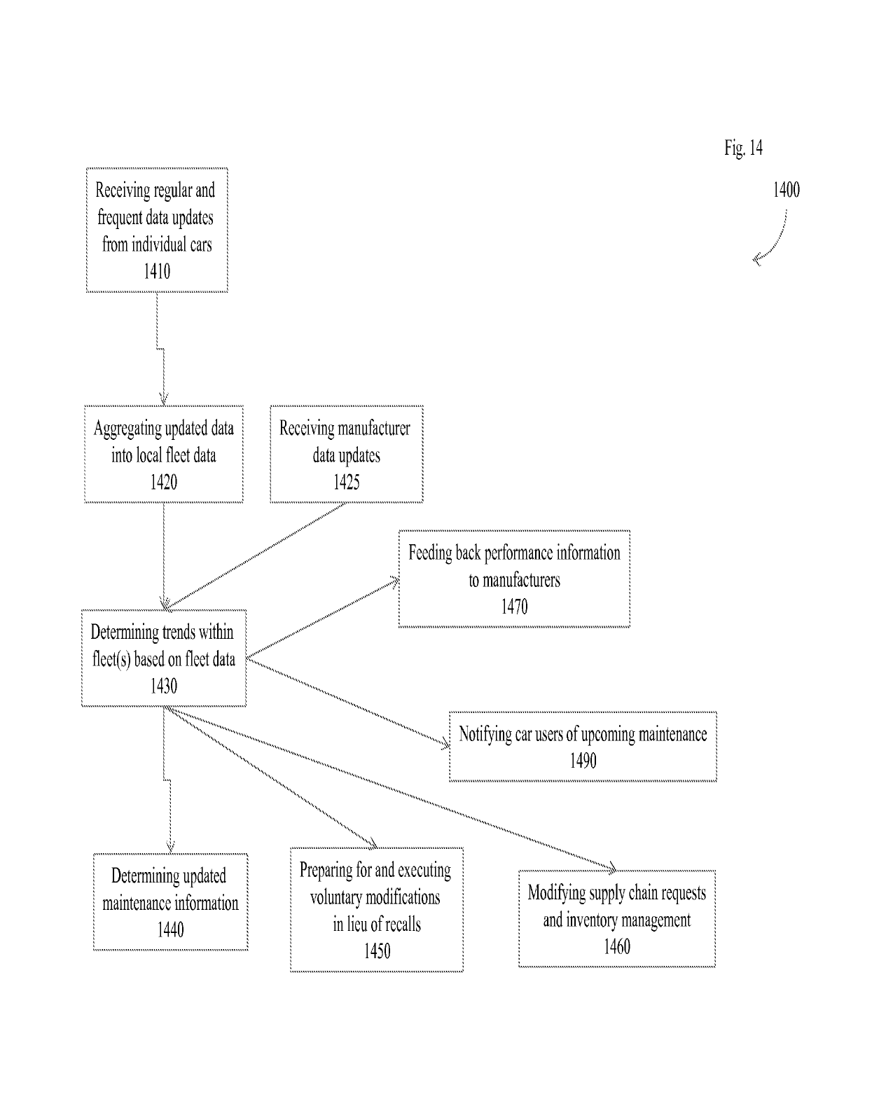

FIG. 14 illustrates another embodiment of a process of receiving and using data about cars. Process 1400 includes receiving data updates, aggregating data, determining trends within the data, and acting based on the data, similarly to process 1300. Process 1400 includes receiving regular and frequent updates from individual cars with data about those cars at module 1410. Modules 1410 and 1420, for example, may be expected to recur regularly, as may be the case with other modules of this process. Data received may include basic information about use of the car, operation of the car, what unexpected or exceptional events are occurring and other data. At module 1420, the data of module 1410 is aggregated to provide local fleet data, e.g. data about cars sold by the dealer or about cars serviced by the dealer, for example. Thus, various cars of a selected make and model may be grouped for data purposes, with the associated data for each car provided as part of a larger database for the make and model as handled by the dealer. Moreover this can allow for anonymization processes. Additionally, at module 1425, data from manufacturers can also be integrated into a database used by the dealer. At module 1430, determinations are made about trends in the data, reflecting how the local fleet of cars are operating. This may lead to a number of different operations. This process may involve use of an application loaded onto a car when the car is received by the dealer, for example, or when the car is serviced by the dealer, for example.

At module 1440, updated repair information is determined, such as potential changes in repair schedules, for example. This may allow for inspection of cars for problems, updated maintenance processes, and other changes to maintenance. Similarly, at module 1450, voluntary modifications to cars may be prepared for and executed, such as in response to a manufacturer request. This may allow a dealer to anticipate problems with cars (e.g. excessive wear or strain on parts) and replace these parts prior to failures which lead to regulatory scrutiny and harmful publicity. Additionally, at module 1460, supply chain requests may be modified, such as through messages to send more parts, provide parts with different specifications, or to stop sending spare parts which do not appear to be in demand. Thus, the dealer can manage inventory of spare parts better and determine if different spare parts are likely to be needed.

Additionally, at module 1470, information is sent back to the manufacturer about performance of cars. This can be model-specific information which may affect an updated design of a model, supply chain factors (which spare parts to produce in high quantities) or voluntary modifications and recalls, for example. This can also involve information about parts common across multiple models or makers of cars, such as information about performance of a powerplant used in various cars, for example. Notification at module 1490 can be sent to users or owners of cars about upcoming scheduled maintenance (e.g. a 30,000 mile or 50,0000 km service is due) or about unexpected maintenance (e.g. please come in to have rotors serviced) due to parts which are trending poorly over a local fleet, for example.

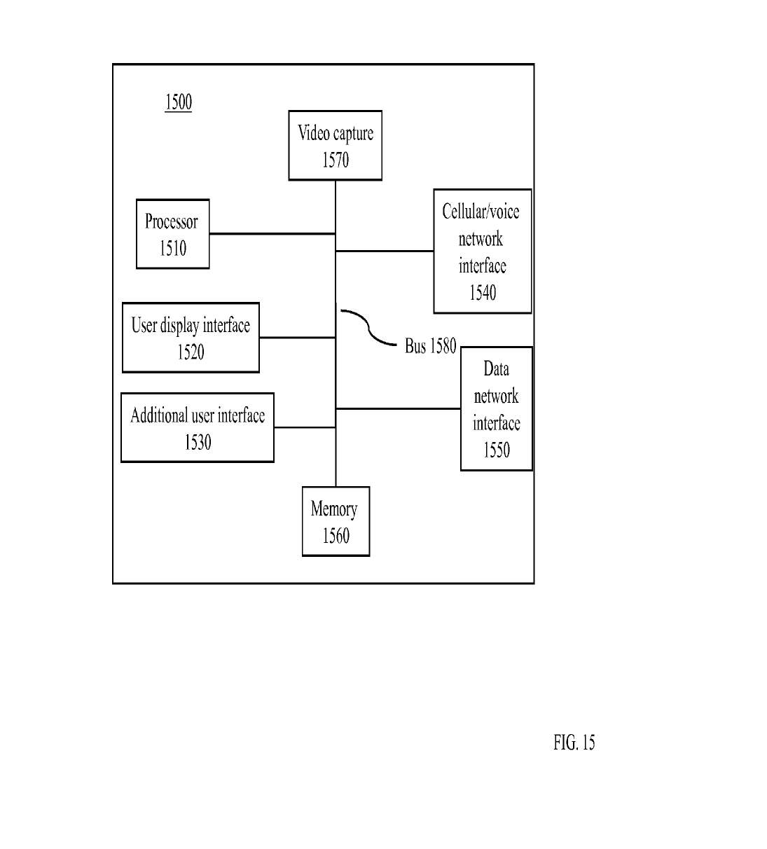

One example of an environment where the described processes can occur and applications can operate is a mobile device. FIG. 15 illustrates an embodiment of a mobile device or machine which may be used with the illustrated and described encoding schemes. Mobile device 1500 includes a processor 1510, user display interface 1520 (e.g. a touchscreen), additional user interface 1530 (e.g. buttons, speaker/microphone, etc.), cellular voice network interface 1540 (e.g. a radio), data network interface 1550 (e.g. one or more data radios), memory 1560 and video capture module 1570 (e.g. an internal camera). Each of these components communicates with processor 1510 through use of bus 1570. Mobile device 1500 may implement the described processes with custom hardware (not shown) or with software, for example.

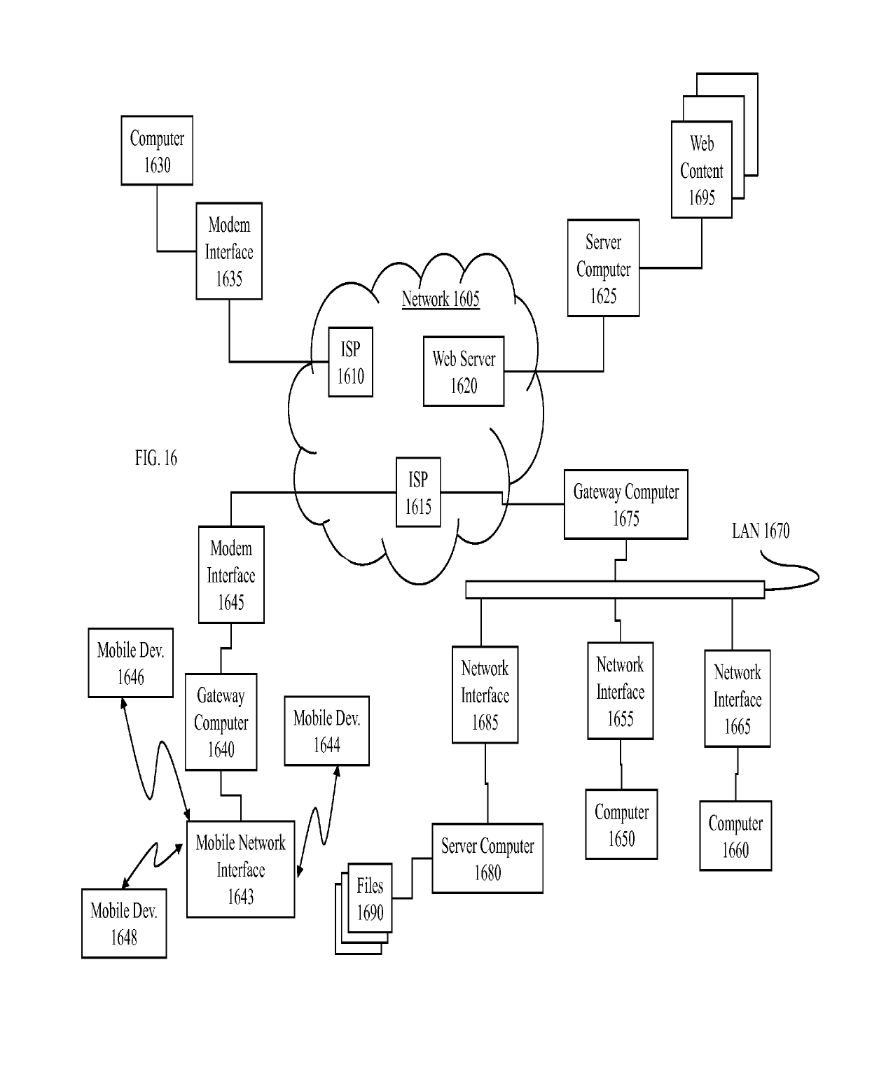

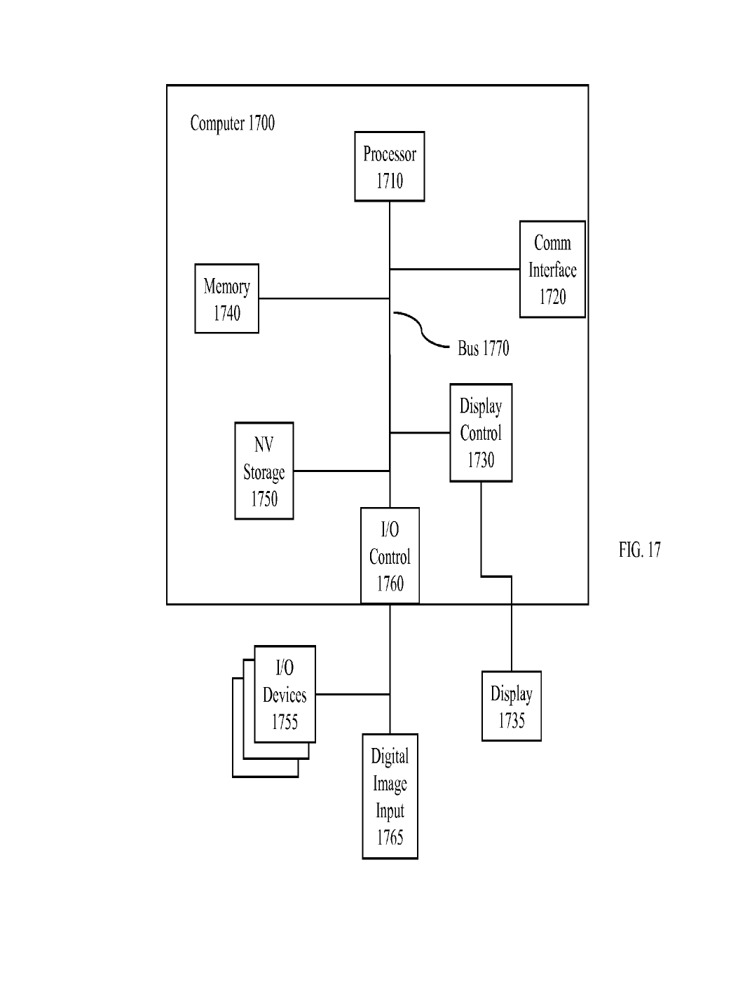

FIG. 16 illustrates an embodiment of a network which may be used with the mobile device of FIG. 15, for example. FIG. 17 illustrates an embodiment of a computer or machine which may be used with the network of FIG. 16 and with the illustrated and described applications and processes, for example. The following description of FIGS. 16-17 is intended to provide an overview of device hardware and other operating components suitable for performing the methods of the invention described above and hereafter, but is not intended to limit the applicable environments. Similarly, the hardware and other operating components may be suitable as part of the apparatuses described above. The invention can be practiced with other system configurations, including personal computers, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 16 shows several computer systems that are coupled together through a network 1605, such as the internet, along with a cellular or other wireless network and related cellular or other wireless devices. The term “internet” as used herein refers to a network of networks which uses certain protocols, such as the TCP/IP protocol, and possibly other protocols such as the hypertext transfer protocol (HTTP) for hypertext markup language (HTML) documents that make up the world wide web (web). The physical connections of the internet and the protocols and communication procedures of the internet are well known to those of skill in the art.

Access to the internet 1605 is typically provided by internet service providers (ISP), such as the ISPs 1610 and 1615. Users on client systems, such as client computer systems 1630, 1650, and 1660 obtain access to the internet through the internet service providers, such as ISPs 1610 and 1615. Access to the internet allows users of the client computer systems to exchange information, receive and send e-mails, and view documents, such as documents which have been prepared in the HTML format. These documents are often provided by web servers, such as web server 1620 which is considered to be “on” the internet. Often these web servers are provided by the ISPs, such as ISP 1610, although a computer system can be set up and connected to the internet without that system also being an ISP.

The web server 1620 is typically at least one computer system which operates as a server computer system and is configured to operate with the protocols of the world wide web and is coupled to the internet. Optionally, the web server 1620 can be part of an ISP which provides access to the internet for client systems. The web server 1620 is shown coupled to the server computer system 1625 which itself is coupled to web content 1695, which can be considered a form of a media database. While two computer systems 1620 and 1625 are shown in FIG. 16, the web server system 1620 and the server computer system 1625 can be one computer system having different software components providing the web server functionality and the server functionality provided by the server computer system 1625 which will be described further below.

Cellular network interface 1643 provides an interface between a cellular network and corresponding cellular devices 1644, 1646 and 1648 on one side, and network 1605 on the other side. Thus cellular devices 1644, 1646 and 1648, which may be personal devices including cellular telephones, two-way pagers, personal digital assistants or other similar devices, may connect with network 1605 and exchange information such as email, content, or HTTP-formatted data, for example.

Cellular network interface 1643 is representative of wireless networking in general. In various embodiments, such an interface may also be implemented as a wireless interface such as a Bluetooth interface, IEEE 802.11 interface, or some other form of wireless network. Similarly, devices such as devices 1644, 1646 and 1648 may be implemented to communicate via the Bluetooth or 802.11 protocols, for example. Other dedicated wireless networks may also be implemented in a similar fashion.

Cellular network interface 1643 is coupled to computer 1640, which communicates with network 1605 through modem interface 1645. Computer 1640 may be a personal computer, server computer or the like, and serves as a gateway. Thus, computer 1640 may be similar to client computers 1650 and 1660 or to gateway computer 1675, for example. Software or content may then be uploaded or downloaded through the connection provided by interface 1643, computer 1640 and modem 1645.

Client computer systems 1630, 1650, and 1660 can each, with the appropriate web browsing software, view HTML pages provided by the web server 1620. The ISP 1610 provides internet connectivity to the client computer system 1630 through the modem interface 1635 which can be considered part of the client computer system 1630. The client computer system can be a personal computer system, a network computer, a web tv system, or other such computer system.

Similarly, the ISP 1615 provides internet connectivity for client systems 1650 and 1660, although as shown in FIG. 16, the connections are not the same as for more directly connected computer systems. Client computer systems 1650 and 1660 are part of a LAN coupled through a gateway computer 1675. While FIG. 16 shows the interfaces 1635 and 1645 as generically as a “modem,” each of these interfaces can be an analog modem, isdn modem, cable modem, satellite transmission interface (e.g. “direct PC”), or other interfaces for coupling a computer system to other computer systems.

Client computer systems 1650 and 1660 are coupled to a LAN 1670 through network interfaces 1655 and 1665, which can be ethernet network or other network interfaces. The LAN 1670 is also coupled to a gateway computer system 1675 which can provide firewall and other internet related services for the local area network. This gateway computer system 1675 is coupled to the ISP 1615 to provide internet connectivity to the client computer systems 1650 and 1660. The gateway computer system 1675 can be a conventional server computer system. Also, the web server system 1620 can be a conventional server computer system.

Alternatively, a server computer system 1680 can be directly coupled to the LAN 1670 through a network interface 1685 to provide files 1690 and other services to the clients 1650, 1660, without the need to connect to the internet through the gateway system 1675.

FIG. 17 shows one example of a personal device that can be used as a cellular telephone (1644, 1646 or 1648) or similar personal device, or may be used as a more conventional personal computer, as an embedded processor or local console, or as a PDA, for example. Such a device can be used to perform many functions depending on implementation, such as monitoring functions, user interface functions, telephone communications, two-way pager communications, personal organizing, or similar functions. The system 1700 of FIG. 17 may also be used to implement other devices such as a personal computer, network computer, or other similar systems. The computer system 1700 interfaces to external systems through the communications interface 1720. In a cellular telephone, this interface is typically a radio interface for communication with a cellular network, and may also include some form of cabled interface for use with an immediately available personal computer. In a two-way pager, the communications interface 1720 is typically a radio interface for communication with a data transmission network, but may similarly include a cabled or cradled interface as well. In a personal digital assistant, communications interface 1720 typically includes a cradled or cabled interface, and may also include some form of radio interface such as a Bluetooth or 802.11 interface, or a cellular radio interface for example.

The computer system 1700 includes a processor 1710, which can be a conventional microprocessor such as an Intel Pentium-based microprocessor (e.g. a Xeon processor, for example) or ARM microprocessor, a Texas Instruments digital signal processor, or some combination of the various types or processors. Memory 1740 is coupled to the processor 1710 by a bus 1770. Memory 1740 can be dynamic random access memory (dram) and can also include static ram (sram), or may include FLASH EEPROM, too. The bus 1770 couples the processor 1710 to the memory 1740, also to non-volatile storage 1750, to display controller 1730, and to the input/output (I/O) controller 1760. Note that the display controller 1730 and I/O controller 1760 may be integrated together, and the display may also provide input.

The display controller 1730 controls in the conventional manner a display on a display device 1735 which typically is a liquid crystal display (LCD) or similar flat-panel, small form factor display. The input/output devices 1755 can include a keyboard, or stylus and touch-screen, and may sometimes be extended to include disk drives, printers, a scanner, and other input and output devices, including a mouse or other pointing device. The display controller 1730 and the I/O controller 1760 can be implemented with conventional well known technology. A digital image input device 1765 can be a digital camera which is coupled to an I/O controller 1760 in order to allow images from the digital camera to be input into the device 1700.

The non-volatile storage 1750 is often a FLASH memory or read-only memory, or some combination of the two. A magnetic hard disk, an optical disk, or another form of storage for large amounts of data may also be used in some embodiments, though the form factors for such devices typically preclude installation as a permanent component of the device 1700. Rather, a mass storage device on another computer is typically used in conjunction with the more limited storage of the device 1700. Some of this data is often written, by a direct memory access process, into memory 1740 during execution of software in the device 1700. One of skill in the art will immediately recognize that the terms “machine-readable medium” or “computer-readable medium” includes any type of storage device that is accessible by the processor 1710 and also encompasses a carrier wave that encodes a data signal. Alternatively, a physical medium may be used as a machine-readable medium or computer-readable medium.

The device 1700 is one example of many possible devices which have different architectures. For example, devices based on an Intel microprocessor often have multiple buses, one of which can be an input/output (I/O) bus for the peripherals and one that directly connects the processor 1710 and the memory 1740 (often referred to as a memory bus). The buses are connected together through bridge components that perform any necessary translation due to differing bus protocols.

In addition, the device 1700 is controlled by operating system software which includes a file management system, such as a disk operating system, which is part of the operating system software. One example of an operating system software with its associated file management system software is the family of operating systems known as Windows CE® and Windows® from Microsoft Corporation of Redmond, Wash., and their associated file management systems. Another example of an operating system software with its associated file management system software is the Palm® operating system and its associated file management system. The file management system is typically stored in the non-volatile storage 1750 and causes the processor 1710 to execute the various acts required by the operating system to input and output data and to store data in memory, including storing files on the non-volatile storage 1750. Other operating systems may be provided by makers of devices, and those operating systems typically will have device-specific features which are not part of similar operating systems on similar devices. Similarly, WinCE® or Palm® operating systems may be adapted to specific devices for specific device capabilities.

Device 1700 may be integrated onto a single chip or set of chips in some embodiments, and typically is fitted into a small form factor for use as a personal device. Thus, it is not uncommon for a processor, bus, onboard memory, and display/I-O controllers to all be integrated onto a single chip. Alternatively, functions may be split into several chips with point-to-point interconnection, causing the bus to be logically apparent but not physically obvious from inspection of either the actual device or related schematics.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

One may expect that the onboard computer of a car will have a similar structure to that of device 1700 of FIG. 17, with some known modifications for use in a car environment. Additionally, one may expect such an onboard computer to operate using a custom operating system, or an operating system designed for use in a car, such as a version of Tizen, for example. Moreover, unlike common personal computers, one may expect the onboard computer of the car to operate at lower processor frequencies and with lower signal frequencies, for example.

One skilled in the art will appreciate that although specific examples and embodiments of the system and methods have been described for purposes of illustration, various modifications can be made without deviating from present invention. For example, embodiments of the present invention may be applied to many different types of cars or other vehicles, for example. Moreover, features of one embodiment may be incorporated into other embodiments, even where those features are not described together in a single embodiment within the present document.

1. A method, comprising:
receiving, in a host car system, an application request in a first format compatible with an application encoding format from an application;
transforming, in the host car system, the application request into a second format compatible with the host car system;
sending, in the host car system, the application request in the second format compatible with the host car system to the host car system;
receiving, in the host car system, a car response from the host car system in the second format compatible with the host car system;
transforming, in the host car system, the car response into the first format compatible with the application encoding format; and
sending, in the host car system, the car response in the first format to the application.

2. The method of claim 1, further comprising:
receiving, in the host car system, the application request in the second format compatible with the host car system;
servicing, in the host car system, the application request in the second format compatible with the host car system;
preparing, in the host car system, the car response in the second format compatible with the host car system responsive to information from servicing the application request in the second format to the host car system;
and
sending, in the host car system, the car response from the host car system in the second format compatible with the host car system.

3. A method, comprising:
receiving, on a mobile device, an application request in a first format compatible with an application encoding format from an application;
transforming, on the mobile device, the application request into a second format compatible with a host car system;
sending, in the mobile device, the application request in the second format to the host car system;
receiving, in the mobile device, a car response from the host car system in the second format compatible with the host car system;
transforming, in the mobile device, the car response into the first format compatible with the application encoding format;
and
sending, in the mobile device, the car response in the first format to the application.

4. The method of claim 3, further comprising:
receiving, in the host car system, the application request in the second format compatible with the host car system;
servicing, in the host car system, the application request in the second format compatible with the host car system;
preparing, in the host car system, the car response in the second format compatible with the host car system responsive to information from servicing the application request in the second format to the host car system;
and
sending, in the host car system, the car response from the host car system in the second format compatible with the host car system.

5. A method, comprising:
receiving a general application prepared for an application interface;
notifying potential collaborators of the general application;
receiving a signal of interest in the general application from a first collaborator;
receiving modification requirements from the first collaborator;
modifying the general application responsive to modification requirements of the first collaborator to create a first modified application;
providing the first modified application to the first collaborator;
receiving a signal of interest in the general application from a second collaborator;
receiving modification requirements from the second collaborator;
modifying the general application responsive to modification requirements of the second collaborator to create a second modified application;
and
providing the second modified application to the second collaborator.

6. (canceled)
